(19) United States
(12) Patent Application Publication
(10) Pub. No.: US 2018/0010219 A1
(43) Pub. Date: Jan. 11, 2018

(54) METHOD OF MANUFACTURING HARD METAL COMPOSITION FOR PRECIOUS METAL

(71) Applicant: Jeong-su Song, Seoul (KR)

(72) Inventor: Jeong-su Song, Seoul (KR)

(21) Appl. No.: 15/135,523

(22) Filed: Apr. 21, 2016

(51) Int. Cl. C22C 29/00; B28B 11/24; B28B 3/00; A44C 9/00; A44C 5/00; A44C 27/00; A44C 17/00; A44C 15/00; C22C 1/05; B22F 9/04

(52) U.S. Cl. CPC C22C 29/005; C22C 1/051; B28B 11/243; B28B 3/00; B22F 9/04; A44C 5/00; A44C 27/006; A44C 17/00; A44C 15/005; A44C 9/00; B22F 2009/043

(57) ABSTRACT

The invention relates to a cemented carbide composition producing method for precious metal, which includes a titanium nitride component contained therein and shows excellent workability, corrosion resistance, reduction in weight and other desirable mechanical properties, as well as the low amount of nickel used as a metallic binder and an aluminum oxide coating helps to suppress potential negative skin reactions.

### BACKGROUND OF THE INVENTION

### Field of the Invention

The present invention relates to a cemented carbide composition producing method for use as precious metal and the resulting cemented carbide, and more particularly, to a cemented carbide composition producing method for precious metal for use as jewelry which exhibits excellent workability, corrosion resistance and mechanical properties.

### Background of the Art

Generally, silver, gold and platinum are used as materials of precious metal for rings, bracelets, necklaces, etc. Although the cost of such precious metal material is high, the longevity is comparatively low and the material subject to abrasion. The material may scratch and lose luster. As such the use of a substitute material as a “precious metal” would be desirable.

In addition there is also a problem that the mass production of such jewelry is difficult and productivity is inefficient, at least because the manufacture rings or necklaces, etc., of precious metal varies depending on factors such as the domestic industry and demand.

As such, cemented carbide formulations have become an alternative precious metal used for some jewelry applications. The hardness which plasticizes the carbide powder of the metal into the superhard alloy used for the cemented carbide also provides for corrosion and abrasion resistance. However, the color and surface gloss characteristics of such materials have been somewhat undesirable for use as jewelry. There has also been problems with a high failure rate of tools and a high processing cost in working with such materials. Moreover, there has been a problem that some people may have allergic reactions to such materials after contact with the skin because the nickel component contained in prior cemented carbide formulations can be harmful.

Accordingly, there is a need for a composition which overcomes such deficiencies, among other things.

### SUMMARY OF THE INVENTION

The cemented carbide composition producing method of the invention results in a product that includes desirable features, such as excellent workability, corrosion resistance, improved mechanical properties and comparative reduction in weight. The product is also relatively less brittle as compared with other products incorporating tungsten carbide, and less likely to scratch or tarnish.

Some embodiments of the invention are directed to a cemented carbide composition producing method for producing a precious metal or precious metal-like product for use as jewelry among other things, which contains a titanium nitride (TiN) component, and which uses a metallic binder having a low content of nickel. In some embodiments, the method includes coating the product with aluminum oxide. In some embodiments, other materials may be added, such as gemstones. The resulting product causes less negative skin reactions and exhibits abrasion resistance and luster.

Some embodiments of the invention are directed to a cemented carbide composition producing method for precious metal which comprises the steps of: mixing a metallic binder in an amount having a percentage by weight of about 10 to about 20%, TiN in an amount having a percentage by weight of about 1 to about 20%, a carbide additive in an amount having a percentage by weight of about 20 to about 40% and tungsten carbide in an amount having a percentage by weight of about 20 to about 49% to form a metal mixture; milling the metal mixture with an organic solvent and paraffin wax added to the metal mixture to form a milled product; drying the milled product in conditions permitting at least the majority of the organic solvent to evaporate to form a dried product; sieving the dried product to remove impurities to form a sieved product; molding the sieved product in a compression molding process to form a molded product; and sintering the molded product.

Some embodiments of the aforementioned method further comprise the step of mixing aluminum oxide powder to the metal mixture in an amount equal to about 1 to 3 parts by weight with the metal mixture being 100 parts by weight.

In some embodiments, the metallic binder comprises one of nickel, cobalt, and a combination of nickel and cobalt. In some embodiments, the metallic binder comprises nickel and cobalt mixed in a ration by weight of 1:3.

In some embodiments, the carbide additive comprises one of chrome carbide, molybdenum carbide, vanadium carbide, tantalum carbide and titanium carbide.

In some embodiments, the organic solvent is added to the metal during the milling step and the milling step comprises using a ball milling apparatus at a charging ratio of metal mixture to ball of between about 4:1 to 5:1, wherein the organic solvent is injected into the ball milling apparatus in an amount equal to about 5 to 20 parts by weight with the metal mixture being 100 parts by weight.

In some embodiments, the ball milling apparatus is operated at a mixing speed of about 30 to about 50 rpm for about 40 to about 80 hours.

In some embodiments, the drying step further comprises drying the milled product at a temperature of about 80 to about 100° C. for about 2 to about 3 hours.

In some embodiments, the sieving step further comprises using mesh size of about 1000 to about 1500.

In some embodiments, the molding step further comprises operating a compression molding process at a pressure of about 5 to about 100 ton/in².

In some embodiments, the sintering step further comprises sintering at a temperature of about 1200 to about 1300° C. for 30 through 60 minutes.

Some embodiments of the aforementioned method further comprise the step of grinding the sintered product.

Some embodiments of the aforementioned method further comprise the step of polishing the sintered product.

Some embodiments of the invention are directed to an item of jewelry, such as for example, a ring, bracelet or necklace, comprising cemented carbide including TiN, a carbide additive and tungsten carbide, wherein the item of jewelry has a hardness of about to about 1050 to 1150 HV and a specific gravity of about 12 to about 13, among other things.

In some embodiments of the item of jewelry of the invention, the TiN is in an amount having a percentage by weight of about 1 to about 20%, the carbide additive is in an amount having a percentage by weight of about 20 to 40% and the tungsten carbide is in an amount having a percentage by weight of about 20 to about 49%, and the particle size ranges from about 1 to about 10 micrometers. The item may further include other materials, such as gemstones.

The remarkable effect providing the cemented carbide composition for the precious metal in which the TiN component is contained and the cemented carbide composition producing method for the precious metal is employed according to the present invention shows excellent workability, corrosion resistance, and other beneficial mechanical properties as well as a reduction in weight property. Moreover, the low amount of metallic binder and reduced content of nickel with the aluminum oxide coating reduces the likelihood of any skin irritations.

### BRIEF DESCRIPTION OF THE DRAWINGS

While the disclosure concludes with claims particularly pointing out and distinctly claiming specific embodiments, various features and advantages of embodiments within the scope of this disclosure may be more readily ascertained from the following description when read in conjunction with the accompanying drawings, in which:

FIG. 1 is a flowchart showing the cemented carbide composition producing method for precious metal according to an embodiment of the present invention; and

FIG. 2 is a flowchart showing the cemented carbide composition producing method for precious metal according to another embodiment of the present invention.

### DETAILED DESCRIPTION OF SOME EMBODIMENTS OF THE INVENTION

The cemented carbide composition producing method according to some embodiments of the invention is described herein below with reference to the figures, where like numerals indicate like or corresponding steps or elements throughout the views.

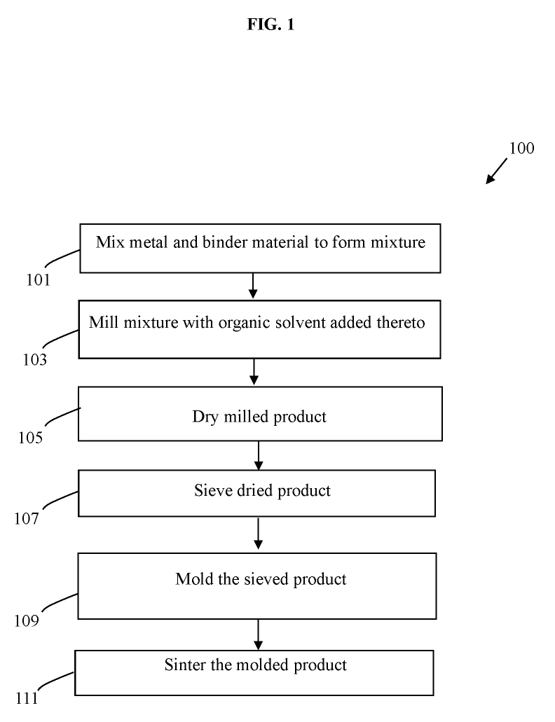

As shown in FIG. 1, a cemented carbide composition producing method 100 may generally comprise a mixing step 101, in which metal and a binder material are mixed and then either combined with an organic solvent to form a metal mixture or combined with an organic solvent during a grinding or milling process in step 103, with the subsequent milled product of reduced particle size being dried in step 105, then filtered or sieved to remove impurities and other undesirable materials in step 107, and molded into a shape in step 109, such as by pressure or compression molding, and then sintered in step 111. It should be understood that the steps may occur successively, such as in an automated processing line, or as batch processes.

The metal mixture of step 101 may include one or more metals and a milled metallic binder, which is about 10 through about 20 weight % of the mixture. The mixture may, for example, include TiN, and/or variants of TiN, such as titanium carbon nitride or titanium aluminum nitride and combinations thereof, at about 1 through about 20 weight %, a carbide additive at about 20 through about 40 weight % and tungsten carbide at about 20 through about 49 weight %. The tungsten carbide may in some embodiments include particles of a size in the range of about 1 through about 10 micrometers. The mixing may involve any conventional mixing apparatus and equipment. The mixture may further include other materials, such as gemstones, which may be ground or otherwise included as particles of various sizes, such as sizes in the range of about 1 through about 10 micrometers.

During this step the metallic binder binds the carbide additive and tungsten carbide thus resulting in increasing the extent of tungsten carbide in the final cemented carbide composition. Nickel and cobalt may be mixed as the binder in the weight rate of 1:3 relative to each other.

As described above, even when the content of the nickel is in an amount which may be likely to cause allergic reactions, it has been found that jewelry using the composition of the invention, in which the metallic binder has nickel and cobalt mixed to the weight rate of 1:3 according to the invention, rarely results in skin trouble. Moreover, the completed alloy of the invention may have a low content of nickel as there is nearly no grain growth in the relatively low temperature of the sintered process.

The hardness of the cemented carbide composition for precious metal is lowered and workability is improved according to the present invention in which there is 1 through 20 weight % of TiN, with the TiN having a particle size of 1 through 10 micrometer.

The carbide additive may be formed of one or more carbides, either alone or in combination, such as chrome carbide, molybdenum carbide, vanadium carbide, tantalum carbide and/or titanium carbide. It has been found that heat resistance and mechanical properties of the cemented carbide composition may be improved when the carbide additive is at 20 through 40 weight % of the composition. A carbide additive of a particle size ranging from about 1 through 10 micrometer is desirable in the composition.

Tungsten carbide having about 20 through about 49 weight % is included in the mixture. It has been discovered that sintering issues, such as pore closure, may occur if tungsten carbide in this content range. It has been found that the addition of nitrogen to the sintering process suppresses grain growth on the carbon nitride, among other things. Moreover, the hardness and density are controlled by the suitable range and the workability can be improved.

Turning to step 103, the metal mixture of step 101 is mixed with an organic solvent and injected into a milling or other suitable apparatus for grinding and blending. In an example, the metal mixture at 100 parts by weight may be combined with hexane up to 20 parts by weight and paraffin wax at 1 to 3 parts by weight and injected into a ball milling apparatus. The mixture may be milled for 40 through 80 hours at a charge ratio of the mixture and ball of 4:1 to 5:1 at a mixing speed 30 through 50 rpm.

In step 105, the resulting milled product is dried which facilitates the removal of the organic solvent added to the mixture in step 103. For example, the drying may occur in a suitable vessel at a temperature of 80 through 100° C. for 2 through 3 hours.

In step 107, the dried product is passed through a filter or sieve. For example, the sieving may be operated by passing the dried product through one or more 1000 through 1500 sized mesh screens so that any components having a particle size more than 10 micrometer are removed by the sieving process prior to step 109.

In step 109 the sieved product is injected into a molding apparatus such as a compression molding apparatus. The sieved product may be compressed at the pressure of 5 through 100 ton/in² for example or 1.5 through 2.5 ton/cm², and shaped prior to the sintering step.

In step 111 the compression molded product is added to the sintering furnace. The sintering may occur while maintaining the vibration ratio within 500 microns and at a temperature of 1200 through 1300° C. for 30 through 60 minutes. The sintering step may also be made at a temperature of 1400 through 1500° C. for 60 minutes.

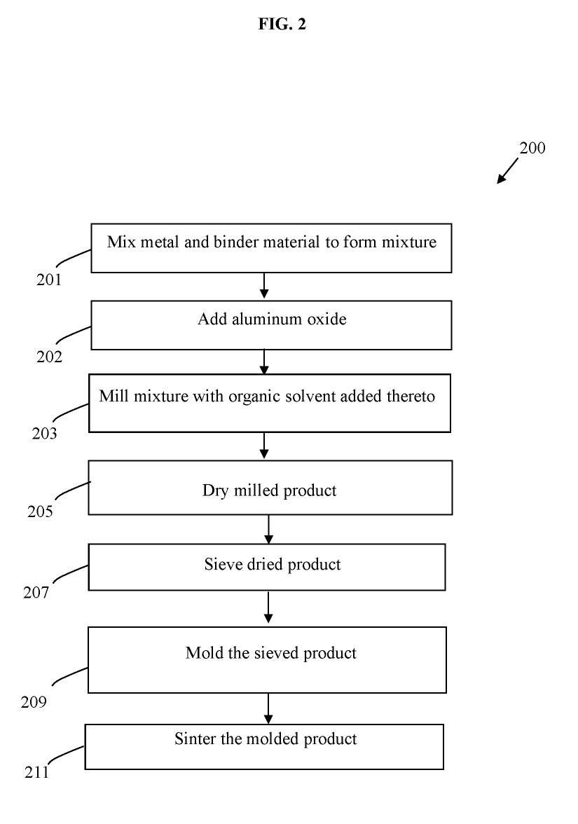

The resulting cemented carbide composition of the invention may then undergo various other steps such as grinding and polishing steps using a Barrel machine etc. until a suitable appearance and form is achieved. Moreover, the process may include other intermediate steps such as a step 202 shown of method 200 in FIG. 2 in which alumina or aluminum oxide is added as a powder at about 1 to about 3 parts by weight to the metal mixture at 100 parts by weight. In some embodiments in which aluminum oxide is added, the aluminum oxide provides a coating on the metal mixture particles. The addition of aluminum oxide has been shown to provide desirable abrasion resistance, reduce the potential for negative skin reactions and improve the luster of the resulting cemented carbide composition. A particle size of the aluminum oxide which is capable of passing through 100 through 325 sized mesh screens has thus far been shown to be desirable.

Exemplary embodiments are provided below.

### Example 1

A mixture of 100 parts by weight included the carbide additive (chrome carbide) 20 weight % and tungsten carbide 40 weight % was made. An organic solvent of 10 parts by weight, a metallic binder (cobalt and nickel is the weight ratio of 1:1) 20 weight %, TiN 20 weight %, included in the mixture at 100 parts by weight, and the paraffin wax 2 parts by weight and hexane was injected in the ball milling apparatus and the charging ratio of the mixture and ball was mixed to 4:1 in the one-state to the mixing speed 40 rpm for 60 hours. A particle size of about 10 microns or less was achieved. The milled product was injected in the dryer and dried at a temperature of 90° C. for 90 minutes. The dried product was sieved using screens of 1250 sized mesh and then compression-molded at a pressure of 50 ton/in², with the molded product being injected in the sintering furnace. The sintering furnace had a vibration ratio within 500 micron and sintering took place at a temperature of 1250° C. for 45 minutes until the cemented carbide of the invention was manufactured.

### Example 2

The same as Example 1, except that the metallic binder (cobalt and nickel was the weight ratio of 3:1) 20 weight %, TiN at 20 weight %, and carbide additive (chrome carbide and tantalum carbide at the weight ratio of 1:1) 20 weight % and tungsten carbide at 40 weight % were mixed. The remaining steps were the same as Example 1 and the cemented carbide was manufactured.

### Example 3

Same as Example 1, except that the metallic binder (cobalt and nickel at the weight ratio of 3:1) 20 weight %, TiN 10 weight %, and carbide additive (chrome carbide and tantalum carbide at the weight ratio of 2:1) 15 weight % and tungsten carbide at 45 weight % were mixed and the cemented carbide for the precious metal was manufactured as in Example 1.

### Example 4

Same as Example 1, except that the metallic binder (cobalt and nickel is the weight ratio of 2:3) 23 weight %, TiN at 5 weight %, and carbide additive (chrome carbide and tantalum carbide is the weight ratio of 2:1) 15 weight % and tungsten carbide at 47 weight % were mixed and the cemented carbide for the precious metal was manufactured as in Example 1.

The hardness of the cemented carbide for the precious metal manufactured with the Examples 1 through 4, and the specific gravity and corrosion resistance were measured and shown in Table 1 below.

TABLE 1

| Example | Hardness (HV) | Specific Gravity | Corrosion resistance |
|---|---|---|---|
| Example 1 | 1050 | 12.10 | Good |
| Example 2 | 1050 | 12.10 | Good |
| Example 3 | 1120 | 12.10 | Good |
| Example 4 | 1150 | 12.20 | Good |

As shown in the table, the hardness, the specific gravity and corrosion resistance of the cemented carbide compositions manufactured according to Examples 1 through 4 of the invention make it suitable for use as a precious metal or to apply to a precious metal.

This written description uses examples to disclose the invention and also to enable any person skilled in the art to practice the invention, including making and using any compositions and products and performing any incorporated methods. The patentable scope of the invention is defined by the claims, and may include other examples that occur to those skilled in the art. Other aspects and features of the invention can be obtained from the drawings, the disclosure and the appended claims. The invention may be practiced otherwise than as specifically described within the scope of the appended claims. It should also be noted, that the steps and/or functions disclosed herein or listed within the appended claims, notwithstanding the order of which steps and/or functions are described or listed therein, are not limited to any specific order of operation.

While exemplary systems and methods, and applications of methods of the invention, have been described herein, it should also be understood that the foregoing is only illustrative of a few particular embodiments with exemplary and/or preferred features, as well as principles of the invention, and that various modifications can be made by those skilled in the art without departing from the scope and spirit of the invention. Therefore, the described embodiments should not be considered as limiting of the scope of the invention in any way. Accordingly, the invention embraces alternatives, modifications and variations which fall within the spirit and scope of the invention as set forth in the claims and equivalents thereto.

What is claimed is:

1. A cemented carbide composition producing method for precious metal which comprises the steps of:
mixing a metallic binder in an amount having a percentage by weight of about 10 to about 20%, TiN in an amount having a percentage by weight of about 1 to about 20%, a carbide additive in an amount having a percentage by weight of about 20 to about 40% and tungsten carbide in an amount having a percentage by weight of about 20 to about 49% to form a metal mixture;
milling the metal mixture with an organic solvent and paraffin wax added to the metal mixture to form a milled product;
drying the milled product in conditions permitting at least the majority of the organic solvent to evaporate to form a dried product;
sieving the dried product to remove impurities to form a sieved product;
molding the sieved product in a compression molding process to form a molded product; and
sintering the molded product.

2. A method according to claim 1, further comprising the step of mixing aluminum oxide powder to the metal mixture in an amount equal to about 1 to 3 parts by weight with the metal mixture being 100 parts by weight.

3. A method according to claim 1, wherein the metallic binder comprises one of nickel, cobalt, and a combination of nickel and cobalt.

4. A method according to claim 1, wherein the metallic binder comprises nickel and cobalt mixed in a ration by weight of 1:3.

5. A method according to claim 1, wherein the carbide additive comprises one of chrome carbide, molybdenum carbide, vanadium carbide, tantalum carbide and titanium carbide.

6. A method according to claim 1, wherein the organic solvent is added to the metal during the milling step and the milling step comprises using a ball milling apparatus at a charging ratio of metal mixture to ball of between about 4:1 to 5:1, wherein the organic solvent is injected into the ball milling apparatus in an amount equal to about 5 to 20 parts by weight with the metal mixture being 100 parts by weight.

7. A method according to claim 6, wherein the ball milling apparatus is operated at a mixing speed of about 30 to about 50 rpm for about 40 to about 80 hours.

8. A method according to claim 1, wherein the drying step further comprises drying the milled product at a temperature of about 80 to about 100° C. for about 2 to about 3 hours.

9. A method according to claim 1, wherein the sieving step further comprises using mesh size of about 1000 to about 1500.

10. A method according to claim 1, wherein the molding step further comprises operating a compression molding process at a pressure of about 5 to about 100 ton/in².

11. A method according to claim 1, wherein the sintering step further comprises sintering at a temperature of about 1200 to about 1300° C. for 30 through 60 minutes.

12. A method according to claim 1, further comprising the step of grinding the sintered product.

13. A method according to claim 1, further comprising the step of polishing the sintered product.

14. An item of jewelry comprising cemented carbide including TiN, a carbide additive and tungsten carbide, wherein the item of jewelry has a hardness of about to about 1050 to 1150 HV and a specific gravity of about 12 to about 13.

15. The item of jewelry as recited in claim 14, wherein the TiN is in an amount having a percentage by weight of about 1 to about 20%, the carbide additive is in an amount having a percentage by weight of about 20 to 40% and the tungsten carbide is in an amount having a percentage by weight of about 20 to about 49%, and the particle size ranges from about 1 to about 10 micrometers.
